(19) United States
(12) Patent Application Publication
(10) Pub. No.: US 2006/0021677 A1
(43) Pub. Date: Feb. 2, 2006

(54) Apparatus and method for vertically adjusting a saw box

(76) Inventor: Robert Hart, Salmon Arm (CA)

Correspondence Address: ANTONY C. EDWARDS, SUITE 200 - 270 HIGHWAY 33 WEST, KELOWNA, BC, V1X 1X7, CA

(21) Appl. No.: 11/187,028

(22) Filed: Jul. 22, 2005

Related U.S. Application Data
(60) Provisional application No. 60/591,592, filed on Jul. 28, 2004.

(51) Int. Cl. B26D 1/00; B23Q 15/00

(52) U.S. Cl. 144/357; 83/13; 83/368; 83/371

(57) ABSTRACT

An apparatus for vertically adjusting a saw box of a gang saw includes rotatable members. When the rotatable members are selectively rotated, actuator arms coupled to the base of the saw box are translated such that the saw box is translated substantially vertically so as to center upper and lower saw gangs with the center of a workpiece being linearly fed into the saw box upon actuating instructions from an optimizer communicating with an upstream scanner.

### CROSS REFERENCE TO RELATED APPLICATION

This application claims priority from U.S. Provisional Patent Application No. 60/591,592 filed Jul. 28, 2004.

### Field of Invention

This invention relates to a method and apparatus for sawing lumber, and more particularly, it relates to a method and apparatus for sawing lumber from a work piece, such as a cant, using a double arbor gang saw.

### BACKGROUND OF THE INVENTION

In the sawmill industry, recovery, which is the most important factor in lumber production, is used to describe the amount of board feet recovered from cutting a log into dimension lumber. Therefore, it is desirable to process work pieces, such as cants, into lumber as fast as possible while yielding maximum center products and minimizing standard side boards. For such purpose, double arbor gang saws are an integral part of most sawmills. A double arbor gang saw is a type of gang saw fitted with several blades on a bottom arbor and a top arbor to share the load of sawing and make simultaneous parallel cuts.

Typically, a gang saw will have equal diameter saws driven from the top and bottom arbors. Thus, a 12 inch double arbor gang saw is capable of processing cants from 4 inches to 12 inches in thickness. Cants up to 6 inches thick are usually processed by the bottom arbor saws only. Cants that are between 8 inches and 10 inches thick are processed by both the top and bottom arbor saws. The bottom 6 inches of such cants are cut by the bottom arbor saws while the top arbor saws process the remaining 2 inches of the 8 inch cant and 4 inches of the 10 inch cant.

The problem with double arbor gang saws available in the art is that the feed speed of the cants is largely governed by the amount of horsepower connected to the bottom arbor saws. The top arbor saws are not activated unless the cant thickness exceeds the radius of the bottom arbor saws, and even when in use, the top arbor saws utilize their full connected horsepower only when processing a cant equal to the diameter of the bottom arbor saws. Thus, the throughput of cants is unnecessarily restricted when processing intermediate sized cants because the horsepower available to the top arbor saws is not being utilized effectively to assist the bottom arbor saws unless the thickness of the cant exceeds the radius of the bottom arbor saws. Intermediate sized cants mean cants that have a thickness greater than the radius of the bottom arbor saws but less than the diameter of the top or bottom arbor saws.

U.S. Pat. No. 6,062,281 to Dockter et al. describes a system for processing logs wherein the saw box is movable upwardly and downwardly. However, such system only provides for movement of the saw box to orient the vertical arbor relative to the log in order for the saws on the vertical arbor to follow a curved saw path.

U.S. Pat. No. 5,722,474 to Raybon et al. provides an apparatus for cutting a cant into boards wherein the position of the gang saw relative to a substantially rectilinear path for the cant may be controlled by way of a hydraulic piston and cylinder arrangement. However, Raybon only provides a pivotable carriage, pivotable in a horizontal plane, to orient a horizontal arbor for curve sawing of logs.

Accordingly, there is a need for an apparatus and method for vertically adjusting a saw box such that the feed speed of a work piece may be increased by distributing the depth of cut required to process a work piece equally between the top arbor saws and the bottom arbor saws such that the usage of horsepower connected to the bottom arbor saw may decrease and so as to optimize feed speed.

### SUMMARY OF THE INVENTION

The object of the present invention is to provide a double arbor gang saw adapted to distribute the usage of horsepower connected to the bottom arbor saws and the top arbor saws such that the feed speed may be increased to achieve greater throughput.

A further object of the present invention is to provide a method of using a double arbor gang saw mounted in a saw box which may be selectively elevated to distribute the usage of horsepower of motors operatively connected to the bottom arbor saws and the top arbor saws such that the feed speed of the infeed conveyor may be increased to achieve greater throughput of workpieces through the gang.

In the present invention, the saw box is selectively elevated by rotatable members mounted to the saw box. Rotating means, such as first and second hydraulic cylinders, selectively rotate the rotatable members which are adapted to transfer force from the cylinders to the saw box by force transfer means mounted to the members such as bell-cranks, cams, or other force re-direction means known in the art. In one embodiment, not intended to be limiting, lugs on the members act as bell-cranks to vertically displace the saw box in a controlled manner. The saw box thus may be translated vertically relative to the infeed so as to center the upper and lower saw gangs on the incoming workpiece.

To control the vertical adjusting of the saw box, firstly, an upstream scanner scans the work piece. A computer then processes the scan data to determine the vertical adjustment to the saw box to process the work piece at the optimum feed speed. The computer or an associated processor such as a programmable logic controller (PLC) actuates the means for vertically translating the saw ox, such as one or both of the first and second hydraulic cylinders so that the saw box is vertically adjusted to a height where the depth of cut of the bottom arbor saws and the upper arbor saws will be equal relative to the work piece being sawn.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side elevation partially cut away view of a gang saw assembly with a vertically adjustable saw box according to the present invention;

FIG. 2 is a side elevation partially cut away view of a prior art, non-vertically adjustable saw box;

FIG. 3 is a cross-section view along line 3-3 in FIG. 6;

FIG. 4 is an enlarged side elevation view of the saw box according to the present invention with the saw box in a lowered position;

FIG. 5 is an enlarged side elevation view of the saw box of FIG. 4 in a raised position; and,

FIG. 6 is a cross sectional view along line 6-6 in FIG. 4.

### DETAILED DESCRIPTION OF EMBODIMENTS OF THE INVENTION

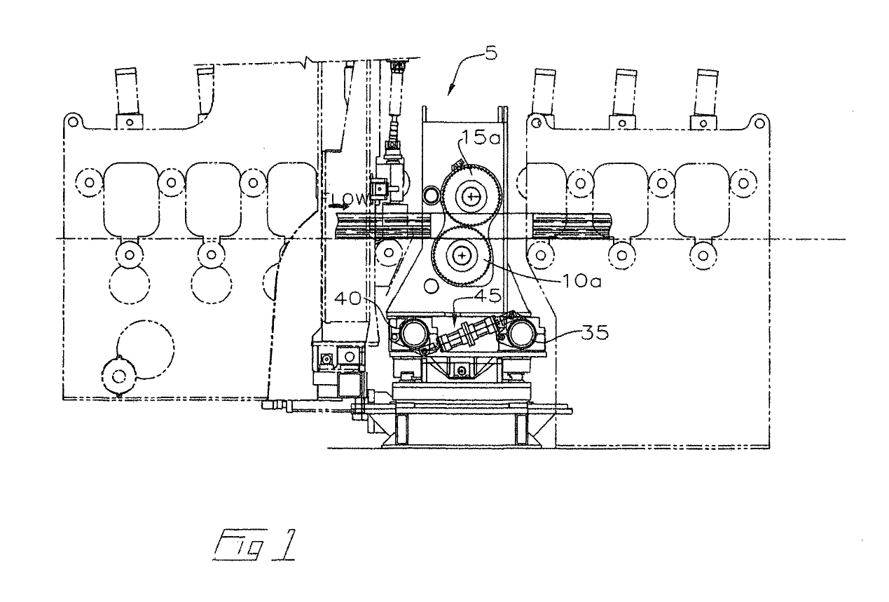

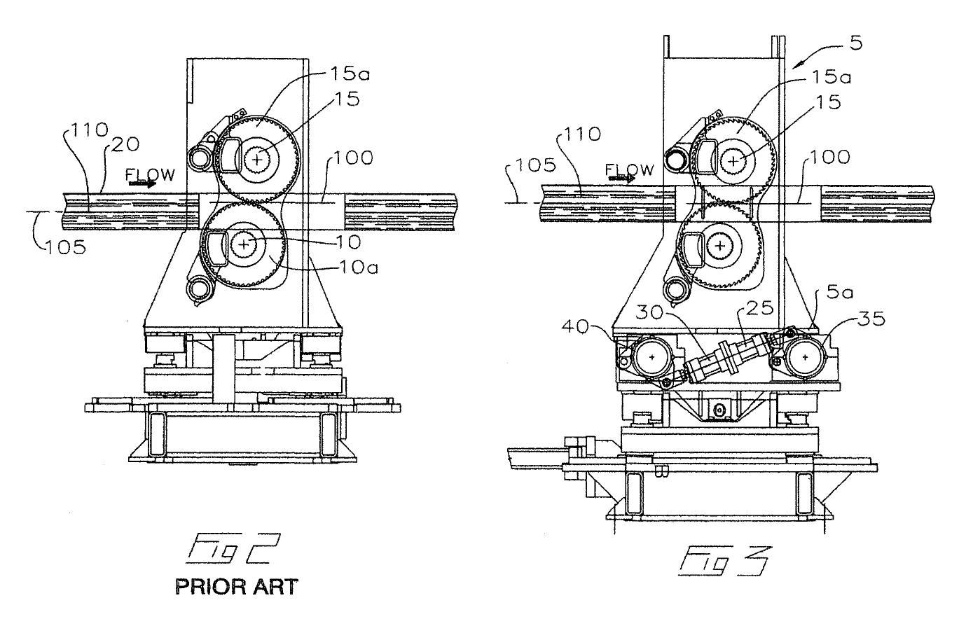

As seen in FIGS. 1 to 3, the present invention comprises a saw box 5. A bottom arbor saw 10 and a top arbor saw 15 are rotatably mounted horizontally in saw box 5, although it is understood that the present invention in intended to apply to vertical arbor sawing. Bottom arbor saw 10 and top arbor saw 15 may be adapted for straight sawing or for curve sawing. Saw box 5 is separate from the infeed and outfeed which to transport a work piece 20 for sawing through saws mounted on bottom arbor saw 10 and top arbor saw 15.

A first hydraulic cylinder 25, a second hydraulic cylinder 30, a first rotatable member 35, and a second rotatable member 40 are mounted underneath saw box 5.

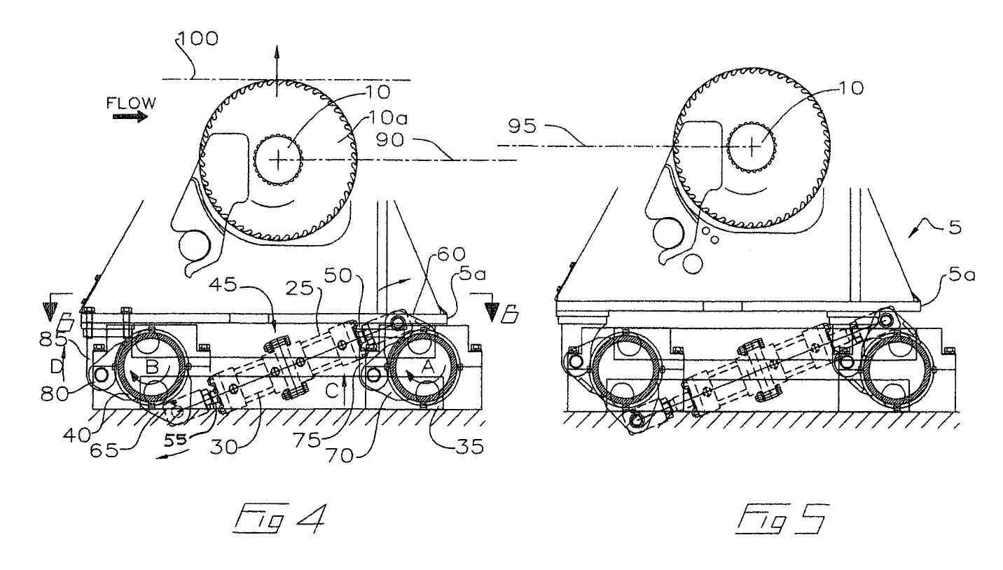

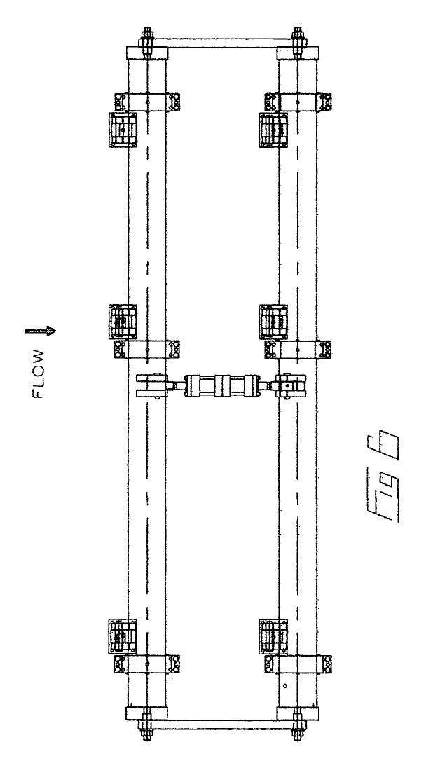

Preferably, first hydraulic cylinder 25 is coupled with second hydraulic cylinder 30 to form a double-acting linearly stacked hydraulic unit 45. Unit 45 is rigidly mounted below saw box 5 and is configured such that a first extendable end 50 of first hydraulic cylinder 25 extends from a first end of unit 45 and a second extendable end 55 of second hydraulic cylinder 30 extends oppositely from a second end of unit 45, as best seen in FIGS. 4 and 5. First extendable end 50 is pivotally coupled with first rotatable member 35 by a first lug 60 and second extendable end 55 is pivotally coupled with second rotatable member 40 by a second lug 65.

As seen in FIG. 4, first lug 60 is pivotally coupled with first rotatable member 35 such that when first hydraulic cylinder 25 extends, first extendable end 50 causes first lug 60 to rotate first rotatable member 35 in direction A. Similarly, second lug 65 is pivotally coupled with second rotatable member 40 such that when second hydraulic cylinder 30 extends, second extendable end 55 causes second lug 65 to rotate second rotatable member 40 in direction B.

A first end of first lug 60 is coupled with first rotatable member 35. A second displacing lug 70 is pivotally coupled with a first arm 75. First arm 75 is rigidly mounted to the base 5a of saw box 5. Similarly, displacing lug 80 is rigidly mounted to second rotatable member 40. The distal end of displacing lug 80 is coupled with a second arm 85. Second arm 85 is rigidly mounted to base 5a of saw box 5. The rotation of first rotatable member 35 and second rotatable member 40 in directions A and B respectively when first hydraulic cylinder 25 and second hydraulic cylinder 30 simultaneously extend causes first displacing lug 70 and second displacing lug 80 to rotate clockwise in the view of FIG. 4, driving first arm 75 and second arm 85 upwardly in directions C and D respectively to vertically adjust saw box 5 upwards so that arbor 10 moves from a first or lower position, indicated in FIG. 4 by horizontal plane 90, to a second or raised position indicated in FIG. 5 by horizontal plane 95.

When first hydraulic cylinder 25 retracts first extendable end 50, first lug 60 and first rotatable member 35 rotate in a counter-clockwise direction in the view of FIG. 4 (that is in a direction opposite to direction A), and when second hydraulic cylinder 30 simultaneously retracts second extendable end 55, second lug 65 and second rotatable member 40 also rotate in a counter-clockwise direction. The rotation of first rotatable member 35 and second rotatable member 40 in a counter-clockwise direction when first hydraulic cylinder 25 and second hydraulic cylinder 30 retract causes first displacing lug 70 and second displacing lug 80 to rotate counterclockwise, thereby lowering first arm 75 and second arm 85 to selectively vertically downwardly adjust saw box 5, bringing arbor 10 downwards from second plane 95 to for example first plane 90 or any position therebetween.

The vertical adjustment of arbor 10 and saw box 5 between first plane 90 and second plane 95 when processing work piece 20 along the saw interface plane 100 with the horizontal plane 105 containing the centerline 110 of the workpiece 20 (for example a cant), wherein centerline 110 is the approximate center of the cant when measured vertically. This optimizes the required power applied to both arbors 10 and 15 and consequently may allow for increasing the feed speed. For example, if bottom arbor saw 10a and top arbor saw 15a each have a radius of 6 inches and the cant is 8 inches thick, bottom arbor saw 10a would typically process the bottom 6 inches of the cant and top arbor saw 15a would process the top 2 inches of the cant. By vertically adjusting saw box 5 vertically downwards by 2 inches, the depth of cut of bottom arbor saw 10a reduces from 6 inches to 4 inches. Similarly, the depth of cut of top arbor saw 15a increases from 2 inches to 4 inches. As a result, bottom arbor saw 10a would process the bottom 4 inches of the cant and top arbor saw 15a would process the top 4 inches of the cant. Because the feed speed is generally governed by the amount of horsepower used by bottom arbor saw 10, the less horsepower used by bottom arbor saw 10a, the faster the feed speed. Since the horsepower used by bottom arbor saw 10a to process 4 inches is less than the horsepower required to process 6 inches, the feed speed to process an 8 inch cant may be in the order of 33% faster when saw box 5 is vertically adjusted to equalize the depth of cut between bottom arbor saw 10a and top arbor saw 15a.

In a further example, if the thickness of the cant is 10 inches, saw box 5 may be adjusted vertically downwards by 1 inch such that bottom arbor saw 10a would process the bottom 5 inches of the cant (as opposed to 6 inches if saw box 5 is not vertically adjusted), top arbor saw 15a would process the top 5 inches of the cant (as opposed to 4 inches if saw box 5 is not vertically adjusted), and the feed speed would be 20% faster if saw box 5 is vertically adjusted. Because of the uneven distribution of horsepower usage between bottom arbor saw 10a and top arbor saw 15a, the efficiency of the feed speed is compromised if saw box 5 is in a position such that the depth of cut of bottom arbor saw 10a is disproportionate to the depth of cut of top arbor saw 15a. By equally sharing the depth of cut required to process work piece 20 between top arbor saw 15a and bottom arbor saw 10a, the horsepower required to process work piece 20 is also equally distributed between bottom arbor saw 10a and top arbor 15, thereby increasing the feed speed.

Preferably, if the thickness of work piece 20 is equal to or less than the radius of bottom arbor saw 10a, saw box 5 should not be vertically adjusted to process such work piece 20. For example, if bottom arbor saw 10a and top arbor saw 15a each have a radius of 6 inches and the cant is 6 inches thick, preferably, bottom arbor saw 10a would process the cant entirely instead of vertically adjusting saw box 5 such that bottom arbor saw 10a would process the bottom 3 inches of the cant and top arbor saw 15a would process the top 3 inches of the cant. By only using bottom arbor saw 10a to process the 6 inch cant, any undesirable mismatch created on the lumber by the use of two saws is avoided. However, if the feed speed is of greater importance than the undesirable mis-match on the lumber, saw box 5 may be vertically adjusted to process a work piece that is equal to or less than the radius of bottom arbor saw 10a.

The steps to vertically adjust saw box 5 to process work piece 20 may include: providing an apparatus for vertically adjusting saw box 5; determining the thickness of work piece 20; determining the appropriate vertical adjustment required to be made to saw box 5 to increase the feed speed based on the thickness of work piece 20; activating hydraulic cylinders 25 and 30 to vertically adjust saw box 5; and processing work piece 20.

Preferably, an optimizing system is provided to scan work piece 20 to determine, among other things not related to the present invention, the thickness of work piece 20. The optimizing system inputs the scan data into a computer which processes the scan data to determine the required vertical adjustment to saw box 5 in order to process work piece 20 at the optimum feed speed. The computer or an associated PLC then implements the vertical adjustment by controlling and actuating first hydraulic cylinder 25 and simultaneously second hydraulic cylinder 30 to vertically adjust saw box 5 to the desired position as determined by the optimizing computer.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for vertically adjusting a saw box of a gang saw wherein an in-feed and out-feed system is detached from the saw box, the apparatus comprising:
a first and a second rotatable member disposed within the saw box;
means for rotating said first and said second rotatable member;
a first and a second arm coupled with the saw box; and
means for displacing said first and said second arm, said means for displacing coupled with each of said first and second rotatable member;
wherein when said means for rotating rotates said first and said second rotatable member, said means for displacing said first and said second arm is actuated such that said first and said second arm displaces the saw box vertically from a first position to a second position.

2. The apparatus of claim 1 wherein the saw box is vertically adjusted such that a bottom and a top saw of the gang saw has an equal depth of cut relative to the thickness of a work piece.

3. The apparatus of claim 2 wherein said means for rotating is a first and a second hydraulic cylinder, said first hydraulic cylinder coupled with said first rotatable member and said second hydraulic cylinder coupled with said second rotatable member.

4. The apparatus of claim 3 wherein said first hydraulic cylinder is coupled with said second hydraulic cylinder to form a stacked hydraulic unit, said unit configured such that a first extendable end of said first hydraulic cylinder extends from a first end of said unit and a second extendable end of said second hydraulic cylinder extends from a second end of said unit.

5. The apparatus of claim 4 wherein said first extendable end is pivotally coupled with said first rotatable member by a first lug and said second extendable end is pivotally coupled with said second rotatable member by a second lug.

6. The apparatus of claim 1 wherein said means for displacing is a first and a second displacing lug, said first displacing lug pivotally coupled with said first rotatable member and said second displacing lug pivotally coupled with said second rotatable member.

7. The apparatus of claim 2 wherein said means for displacing is a first and a second displacing lug, said first displacing lug pivotally coupled with said first rotatable member and said second displacing lug pivotally coupled with said second rotatable member.

8. The apparatus of claim 3 wherein said means for displacing is a first and a second displacing lug, said first displacing lug pivotally coupled with said first rotatable member and said second displacing lug pivotally coupled with said second rotatable member.

9. The apparatus of claim 4 wherein said means for displacing is a first and a second displacing lug, said first displacing lug pivotally coupled with said first rotatable member and said second displacing lug pivotally coupled with said second rotatable member.

10. The apparatus of claim 5 wherein said means for displacing is a first and a second displacing lug, said first displacing lug pivotally coupled with said first rotatable member and said second displacing lug pivotally coupled with said second rotatable member.

11. The apparatus of claim 6 wherein said first and said second displacing lug is adapted to rotate in the same direction as said first and said second rotatable member.

12. The apparatus of claim 11 wherein said first displacing lug is further pivotally coupled with said first arm and said second displacing lug is further pivotally coupled with said second arm.

13. The apparatus of claim 12 wherein when said first and said second rotatable member rotate in a clockwise direction, said first and said second displacing lug rotates in the same direction and drives said first and said second arm respectively such that the saw box is vertically adjusted upwards.

14. The apparatus of claim 13 wherein when said first and said second rotatable member rotates in a counter clockwise direction, said first and said second displacing lug rotates in the same direction and retracts said first and said second arm respectively such that the saw box is vertically adjusted downwards.

15. An apparatus for vertically adjusting a saw box of a gang saw wherein an in-feed and out-feed system is detached from the saw box, the apparatus comprising:
a first and a second rotatable member disposed within the saw box;
a first and a second hydraulic cylinder adapted to rotate said first and said second rotatable member, respectively, said first hydraulic cylinder coupled with said first rotatable member and said second hydraulic cylinder coupled with said second rotatable member;
a first and a second arm coupled with the saw box;
a first and a second displacing lug adapted to displace said first and said second arm, respectively, said first displacing lug coupled with said first rotatable member and said second displacing lug coupled with said second rotatable member;
wherein when said first and said second hydraulic cylinder extends, said first and said second rotatable member rotates in a clockwise direction, causing said first and said second displacing lug to drive said first and said second arm respectively such that the saw box adjusts vertically upwards from a first position to a second position; and
wherein when said first and said second hydraulic cylinder retracts, said first and said second rotatable member rotates in a counter clockwise direction, causing said first and said second displacing lug to retract said first and said second arm respectively such that the saw box adjusts vertically downwards from said second position to said first position.

16. The apparatus of claim 15 wherein the saw box is vertically adjusted such that a bottom and a top saw of the gang saw has an equal depth of cut relative to the thickness of a work piece.

17. The apparatus of claim 16 wherein said first hydraulic cylinder is coupled with said second hydraulic cylinder to form a stacked hydraulic unit, said unit configured such that a first extendable end of said first hydraulic cylinder extends from a first end of said unit and a second extendable end of said second hydraulic cylinder extends from a second end of said unit.

18. The apparatus of claim 17 wherein said first extendable end is pivotally coupled with said first rotatable member by a first lug and said second extendable end is pivotally coupled with said second rotatable member by a second lug.

19. The apparatus of claim 15 wherein said first displacing lug is further pivotally coupled with said first arm and said second displacing lug is further pivotally coupled with said second arm.

20. The apparatus of claim 16 wherein said first displacing lug is further pivotally coupled with said first arm and said second displacing lug is further pivotally coupled with said second arm.

21. The apparatus of claim 17 wherein said first displacing lug is further pivotally coupled with said first arm and said second displacing lug is further pivotally coupled with said second arm.

22. The apparatus of claim 18 wherein said first displacing lug is further pivotally coupled with said first arm and said second displacing lug is further pivotally coupled with said second arm.

23. A method of vertically adjusting a saw box of a gang saw wherein an in-feed and out-feed system is detached from the saw box, the method comprising the steps of:
providing a means for scanning a work piece;
scanning said work piece to obtain data on the thickness of said work piece;
using said data to determine the amount of vertical adjustment to the saw box such that a bottom and a top saw of the gang saw will process an equal depth of cut relative to said work piece;
providing an apparatus for vertically adjusting the saw box of the gang saw, the apparatus comprising:
a first and a second rotatable member disposed within the saw box;
means for rotating said first and said second rotatable member;
a first and a second arm coupled with the saw box;
means for displacing said first and said second arm, said means for displacing coupled with each of said first and second rotatable member;
wherein when said means for rotating rotates said first and said second rotatable member, said means for displacing said first and said second arm is actuated such that said first and said second arm displaces the saw box vertically from a first position to a second position; and
activating said means for rotating said first and said second rotatable member to vertically adjust the saw box.

24. The method of claim 23 wherein said means for scanning is an optimizing system.

25. The method of claim 24 wherein said optimizing system inputs said data into a processor.

26. The method of claim 25 wherein said processor determines said amount of vertical adjustment to the saw box and said processor activates said means for rotating.

27. A method of vertically adjusting a saw box of a gang saw wherein an in-feed and out-feed system is detached from the saw box, the method comprising the steps of:
providing an optimizing system adapted to scan a work piece;
scanning said work piece to obtain data on the thickness of said work piece;
inputting said data to a processor to determine the amount of vertical adjustment to the saw box such that a bottom and a top saw of the gang saw will process an equal depth of cut;
providing an apparatus for vertically adjusting the saw box of the gang saw, the apparatus comprising:
a first and a second rotatable member disposed within the saw box;
a first and a second hydraulic cylinder adapted to rotate said, first and said second rotatable member, respectively, said first hydraulic cylinder pivotally coupled with said first rotatable member and said second hydraulic cylinder pivotally coupled with said second rotatable member;
a first and a second arm coupled with the saw box;
a first and a second displacing lug adapted to displace said first and said second arm, respectively, said first displacing lug pivotally coupled with said first rotatable member and said second displacing lug pivotally coupled with said second rotatable member;
wherein when said first and said second hydraulic cylinder extends, said first and said second rotatable member rotates in a clockwise direction, causing said first and said second displacing lug to drive said first and said second arm respectively such that the saw box adjusts vertically upwards from a first position to a second position; and
wherein when said first and said second hydraulic cylinder retracts, said first and said second rotatable member rotates in a counter clockwise direction, causing said first and said second displacing lug to retract said first and said second arm respectively such that the saw box adjusts vertically downwards from said second position to said first position.
activating said first and said second hydraulic cylinder to vertically adjust the saw box.
